(19) United States
(12) Patent Application Publication
(10) Pub. No.: US 2006/0250340 A1
(43) Pub. Date: Nov. 9, 2006

(54) Display apparatus

(75) Inventors: Hak-Sun Chang, Yongin-si (KR); Hee-Wook Do, Suwon-si (KR); Chang-Hun Lee, Yongin-si (KR); Hyun-Wuk Kim, Yongin-si (KR)

Correspondence Address: F. CHAU & ASSOCIATES, LLC, 130 WOODBURY ROAD, WOODBURY, NY, 11797, US

(73) Assignee: Samsung Electronics Co., Ltd., Suwon-si (KR)

(21) Appl. No.: 11/416,218

(22) Filed: May 2, 2006

(30) Foreign Application Priority Data
May 3, 2005 (KR) 2005-36962

(51) Int. Cl. G09G 3/36

(52) U.S. Cl. 345/88

(57) ABSTRACT

A display apparatus includes a first substrate, a pixel electrode, a second substrate and a common electrode. The first substrate includes a dot area having a plurality of pixel areas having at least two different sizes among the plurality of pixel areas. Each of the pixel areas forms a predetermined angle with respect to a line in a first direction of the first substrate. The pixels areas extend substantially symmetrically from the line in the first direction. The pixel electrode is disposed on the first substrate. The common electrode is disposed on a surface of the second substrate adjacent to the pixel electrode.

### CROSS-REFERENCE TO RELATED APPLICATION

This application claims priority to Korean Patent Application No. 2005-36962 filed on May 3, 2005, the disclosure of which is herein incorporated by reference in its entirety.

### BACKGROUND OF THE INVENTION

1. Field of the Invention

The present invention relates to a display apparatus, and more particularly, to a display apparatus capable of improving image display quality.

2. Description of Related Art

A liquid crystal display apparatus typically includes a first substrate having a pixel electrode, a second substrate having a common electrode and a liquid crystal layer interposed between the first and second substrates. An alignment of liquid crystals of the liquid crystal layer varies in response to an electric field applied thereto, and thus a light transmittance of the liquid crystal layer is changed, thereby displaying an image.

To increase a viewing angle of the liquid crystal display apparatus, a patterned vertical alignment (PVA) mode, a multi-domain vertical alignment (MVA) mode or an in-plain switching (IPS) mode may be implemented.

The pixel electrode and the common electrode of the liquid crystal display apparatus implementing the PVA mode are patterned to divide a pixel area into a plurality of domains, wherein the liquid crystals are aligned along the domains to increase the viewing angle.

The liquid crystal display apparatus implementing the PVA mode includes a plurality of dot areas. Each of the dot areas typically includes three pixel areas. The three pixel areas have substantially the same structure and dimensions. The common electrode and the pixel electrode in each of the pixel areas include a plurality of opening portions. When the number of the opening portions is increased, a width of each of the domains is decreased to increase a response speed of the liquid crystals. Further, an opening ratio of the liquid crystal display apparatus is decreased as the number of the opening portions is increased. When the number of the opening portions is decreased, the width of each of the domains is increased and the opening ratio of the liquid crystal display apparatus is increased. Further, the response speed of the liquid crystals is decreased as the number of the opening portions is decreased.

Therefore, a need exists for a display apparatus having a high speed and a high opening ratio for improved image display quality.

### SUMMARY OF THE INVENTION

A display apparatus according to an embodiment of the present invention includes a first substrate, a pixel electrode, a second substrate and a common electrode.

The first substrate includes a dot area having a plurality of pixel areas having at least two different sizes among the plurality of pixel areas. Each of the pixel areas forms a predetermined angle with respect to a line in a first direction of the first substrate. The pixels areas extend substantially symmetrical from the line in the first direction. The pixel electrode is disposed on the first substrate. The common electrode is disposed on a surface of the second substrate adjacent to the pixel electrode.

### BRIEF DESCRIPTION OF THE DRAWINGS

Embodiments of the present invention will become readily apparent by reference to the detailed description when considered in conjunction with the accompanying drawings wherein:

FIG. 1 is a plan view illustrating a liquid crystal display apparatus according to an embodiment of the present invention;

FIG. 2 is a cross sectional view taken along a line I-I′ of FIG. 1;

FIG. 3 is a plan view illustrating a method of arranging red (R), green (G) and blue (B) color pixels shown in FIG. 2;

FIG. 4 is a plan view illustrating a method of arranging red (R), green (G) and blue (B) color pixels in accordance with another embodiment of the present invention;

FIG. 5 is a plan view illustrating a liquid crystal display apparatus according to another embodiment of the present invention;

FIG. 6 is a plan view illustrating a liquid crystal display apparatus according to another embodiment of the present invention;

FIG. 7 is a plan view illustrating a method of arranging red (R), green (G) and blue (B) color pixels of a liquid crystal display apparatus shown in FIG. 6; and

FIG. 8 is a plan view illustrating a method of arranging red (R), green (G) and blue (B) color pixels in accordance with another embodiment of the present invention.

### DETAILED DESCRIPTION OF PREFERRED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

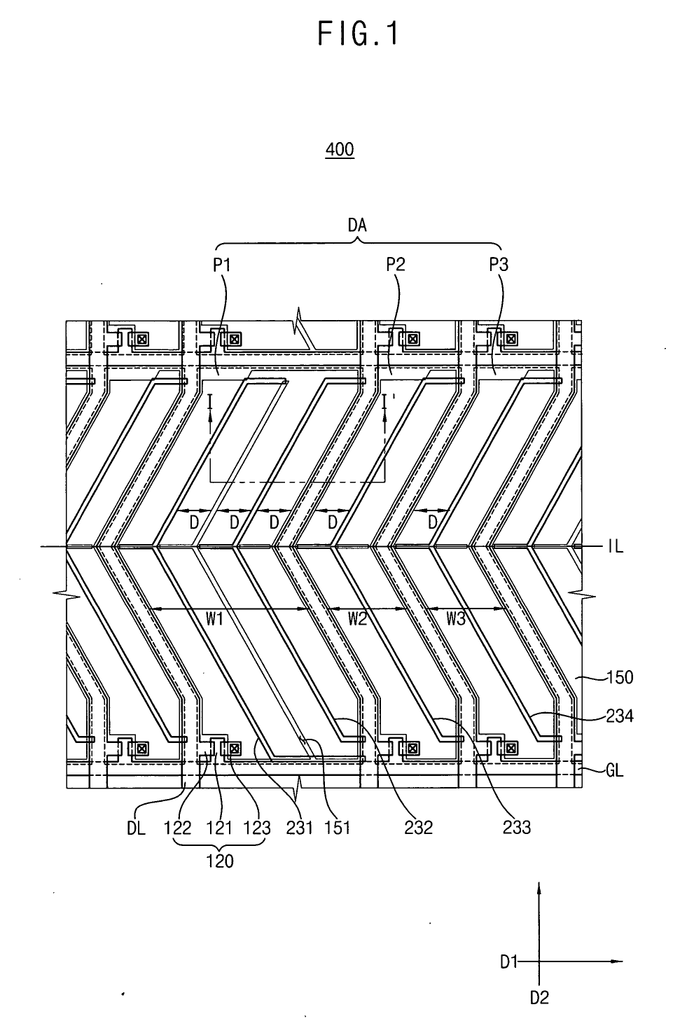

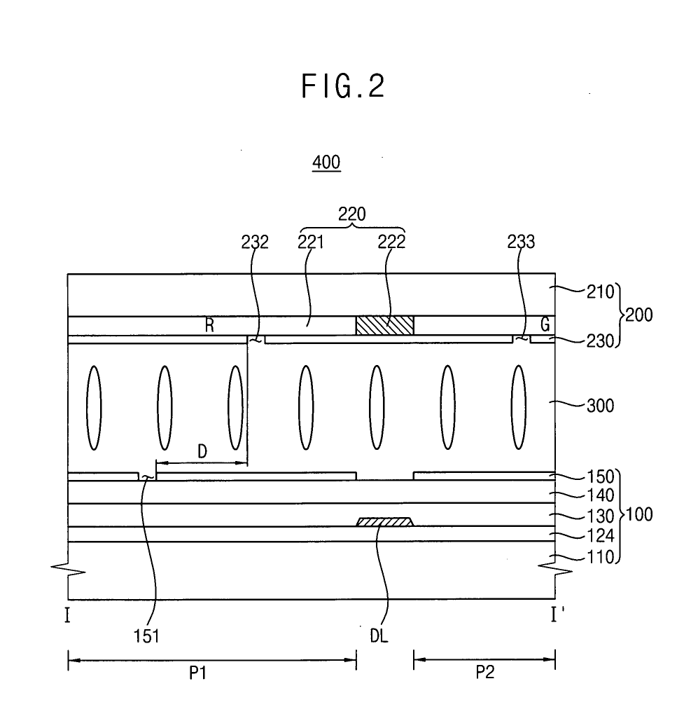

FIG. 1 is a plan view illustrating a liquid crystal display apparatus according to an embodiment of the present invention. FIG. 2 is a cross sectional view taken along a line I-I′ in FIG. 1.

Referring to FIGS. 1 and 2, the liquid crystal display apparatus 400 includes a plurality of dot areas DA. An image is displayed in the dot areas DA. Each of the dot areas DA includes first, second and third pixel areas P1, P2 and P3. For example, the first, second and third pixel areas P1, P2 and P3 correspond to red, green and blue colors, respectively. The red, green and blue colors combine to display a dot image portion corresponding to each of the dot areas DA. A plurality of dot image portions form the image in the dot areas DA.

Each of the first, second and third pixel areas P1, P2 and P3 extends from a central line IL of the first, second and third pixel areas P1, P2 and P3 in a direction that forms a predetermined angle with respect to a second direction D2. Each of the first, second and third pixel areas P1, P2 and P3 may be substantially symmetrically extended from the central line IL. Each of the first, second and third pixel areas P1, P2 and P3 may comprise angled portions inclined with respect to the central line IL. Each of the first, second and third pixel areas P1, P2 and P3 has a V shape when viewed on a plane (e.g., as shown in FIG. 1), wherein the angled portions are symmetrical with respect to the central line IL.

The first, second and third pixel area P1, P2 and P3 are arranged along a first direction D1 that is substantially perpendicular to the second direction D2. The first pixel area P1 has a greater size than each of the second and third pixel areas P2 and P3. In FIGS. 1 and 2, the first, second and third pixel areas P1, P2 and P3 have substantially the same length (e.g., a dimension in the second direction D2). A width W1 of the first pixel area P1, a width W2 of the second pixel area P2 and a width W3 of the third pixel area P3 (e.g., dimensions in the first direction D1) are different from each other. The width W1 of the first pixel area P1 may be greater than each of the widths W2 and W3 of the second and third pixel areas P2 and P3. The width W2 of the second pixel area P2 may be substantially the same as the width W3 of the third pixel area P3.

The liquid crystal display apparatus 400 includes a first substrate 100, a second substrate 200 and a liquid crystal layer 300 interposed between the first and second substrates 100 and 200.

The first substrate 100 includes a first transparent substrate 110, gate lines GL on the first transparent substrate 110, data lines DL on the first transparent substrate 110 and a thin film transistor (TFT) 120 electrically connected to the gate and data lines GL and DL.

The gate lines GL extend in the first direction D1, and transmit gate signals to the first, second and third pixel areas P1, P2 and P3.

The data lines DL extend in the second direction D2, and transmit data signals to the first, second and third pixel areas P1, P2 and P3. In FIGS. 1 and 2, the data lines DL extend along the V-shaped sides of the first, second and third pixel areas P1, P2 and P3. The data lines DL form the predetermined angle with respect to the second direction D2. Alternatively, the data lines DL may not form the predetermined angle with respect to the second direction D2, and may form a linear shape that is substantially parallel to the second direction D2.

Each of the thin film transistors 120 includes a gate electrode 121 electrically connected to one of the gate lines GL, a source electrode 122 electrically connected to one of the data lines DL and a drain electrode 123 spaced apart from the source electrode 122. A thin film transistor 120 is disposed in each of the pixel areas P1, P2 and P3. Alternatively, more than one thin film transistor 120 may be disposed in each of the pixel areas P1, P2 and P3.

The first substrate 100 may further include a gate insulating layer 124 for protecting the gate lines GL and the gate electrode 121. The first substrate 100 may further include a protecting film 130 for protecting the data lines DL and the thin film transistors 120. The first substrate 100 may further include an organic insulating film 140, and a pixel electrode 150 electrically connected to each of the thin film transistors 120.

The gate insulating film 124 is disposed on the first transparent substrate 110 having the gate lines GL and the gate electrode 121. The data lines DL and the source and drain electrodes 122 and 123 are formed on the gate insulating film 124.

The protecting film 130 is disposed on the gate insulating film 124 having the data lines DL and the source and drain electrodes 122 and 123. The organic insulating film 140 is disposed on the protecting film 130.

The pixel electrode 150 is disposed on the organic insulating film 140. The pixel electrode 150 includes a transparent conductive metal. Examples of the transparent conductive material that can be used for the pixel electrode 150 include indium tin oxide (ITO), tin oxide (TO), indium tin-zinc oxide (ITZO), zinc oxide (ZO), indium zinc oxide (IZO), etc.

The pixel electrode 150 corresponds to each of the first, second and third pixel areas P1, P2 and P3, and applies a signal voltage to the liquid crystal layer 300. The signal voltage is applied to each of the first, second and third pixel areas P1, P2 and P3 by the pixel electrode 150. In FIGS. 1 and 2, the signal voltage applied to each of the first, second and third pixel areas P1, P2 and P3 is substantially the same. Alternatively, signal voltages applied to the first, second and third areas P1, P2 and P3 may be different.

The pixel electrode 150 is partially removed to form a pixel opening portion 151 in the first pixel area P1. A center of the pixel opening portion 151 is on the central line IL, and the pixel opening portion 151 extends from the central line IL.

The pixel opening portion 151 forms the predetermined angle with respect to the second direction D2, and is arranged substantially parallel to the V-shaped sides of the first pixel area P1. Therefore, the pixel opening portion 151 has a V shape when viewed on a plane. A width of an upper portion of the pixel opening portion 151 may be substantially the same as that of a lower portion of the pixel electrode 151.

The second substrate 200 is disposed on the first substrate 100. The second substrate 200 includes a second transparent substrate 210, a color filter layer 220 disposed on the second transparent substrate 210 and a common electrode 230 disposed on the color filter layer 220.

The color filter layer 220 includes red (R), green (G) and blue (B) color pixels 221 that generate red, green and blue light, respectively, and a black matrix 222 surrounding the R, G and B color pixels 221 to decrease a leakage of the red, green and blue light generated from the R, G and B color pixels 221. The R, G and B color pixels 221 correspond to the first, second and third pixel areas P1, P2 and P3, respectively.

In FIGS. 1 and 2, the second substrate 200 includes the R, G and B color pixels 221. Alternatively, the first substrate 100 may include the R, G and B color pixels 221 on the organic insulating film 140.

The common electrode 230 includes a transparent conductive metal. The common electrode 230 may include substantially the same material as the pixel electrode 150. Examples of the transparent conductive material that can be used for the common electrode 230 include indium zinc oxide (IZO), zinc oxide (ZO), tin oxide (TO), indium tin oxide (ITO), indium tin-zinc oxide (ITZO), etc. A common voltage is applied to the common electrode 230, and an electric field is formed in the first, second and third pixel areas P1, P2 and P3 between the common electrode and the pixel electrode 150.

The common electrode 230 is partially removed to form first, second, third and fourth common opening portions 231, 232, 233 and 234 in the first, second and third pixel areas P1, P2 and P3. The color filter layer 220 is partially exposed through the first, second, third and fourth common opening portions 231, 232, 233 and 234. A center of each of the first, second, third and fourth common opening portions 231, 232, 233 are 234 is disposed on the central line IL, and each of the first, second, third and fourth common opening portions 231, 232, 233 and 234 extends substantially parallel to the inclined sides of each of the first, second and third pixel regions P1, P2 and P3. Each of the first, second, third and fourth common opening portions 231, 232, 233 and 234 forms the predetermined angle with respect to the second direction D2.

The first and second common opening portions 231 and 232 are formed in the first pixel area P1. The first and second common opening portions 231 and 232 are formed on opposite sides with respect to the pixel opening portion 151 in the first pixel area P1. A distance between the first common opening portion 231 and the pixel opening portion 151 in the first pixel area P1 is substantially the same as a distance between the second common opening portion 232 and the pixel opening portion 151 in the first pixel area P1.

The third common opening portion 233 is formed in the second pixel area P2. The third common opening portion 233 is formed on a center of the second pixel area P2.

The fourth common opening portion 234 is formed in the third pixel area P3. The fourth common opening portion 234 is formed on a center of the third pixel area P3.

A plurality of domains are formed in the dot areas DA by the first, second, third and fourth common opening portions 231, 232, 233 and 234 of the common electrode 230 and the pixel opening portion 151 of the pixel electrode 150. In FIGS. 1 and 2, the pixel opening portion 151 and the first and second common opening portions 231 and 232 are formed in the first pixel area P1, and the third and fourth common opening portions 233 are 234 are formed in the second and third pixel areas P2 and P3, respectively. In FIGS. 1 and 2, the pixel opening portion 151 is only formed in the first pixel area P1.

A width D of each of the domains is substantially the same. For example, the width D of each of the domains may be about 15 μm to about 401 μm. Sizes of the first, second and third pixel areas P1, P2 and P3 are different from each other. The width D of each of the domains is substantially the same.

A liquid crystal display apparatus may include a dot area having three pixels that have substantially the same size area and structure. For example, when each of the three pixel areas of the dot area includes one pixel opening portion 151 and two common opening portions 231, 232, 233 and 234; a width DW1 of the dot area may be determined using Equation 1.
DW1={(width of domain)×(number of domains arranged in second direction)}+{(width of opening portion in each of pixel electrode and common electrode)×(number of opening portions arranged in second direction)}
DW1=(width of domain×12)+(width of opening portion in each of pixel electrode and common electrode×9) Equation 1

In Equation 1, the width DW1 of the dot area having the three pixel areas that have substantially the same size area and structure is determined from a sum of a summation of the widths of the domains and a summation of the widths of the opening portions in each of the pixel electrode and the common electrode. For example, when the width of each of the domains is about 20 μm and the width of each of the opening portions is about 11 μm, the width DW1 of the dot area having the three pixel areas that have substantially the same size of area and structure is about 339 μm.

The width DW2 of the dot area of the liquid crystal display apparatus 400 (shown in FIGS. 1 and 2) may be determined using Equation 2. For example, the width DW2 of each of the dot areas DA of the liquid crystal display apparatus 400 (shown in FIGS. 1 and 2) is substantially the same as the width DW1 of the dot area having the three pixel areas that have substantially the same size area and structure. The width of each of the pixel opening portion 151 and the first, second, third and fourth common opening portions 231, 232, 233 and 234 is about 11 μm, and substantially the same as the width of each of the opening portions of the dot area having the three pixel areas that have substantially the same size area and structure. The distance between adjacent two of the first, second and third pixel areas P1, P2 and P3 is substantially the same.
DW2=(width of domain×8)+(width of pixel opening portion×1)+(width of common opening portion×4)
399=(width of domain×8)+55
Width of domain=(339−55)÷8=35.5 Equation 2

Referring to Equation 2, when the width DW2 of each of the dot areas DA is about 339 μm, the width D of each of the domains is about 35.5 μm. The width D of each of the domains of the liquid crystal display apparatus 400 (shown in FIGS. 1 and 2) is greater than the width of each of the domains of the dot area having the three pixel areas that have substantially the same size area and structure by about 15.5 μm. The liquid crystal display apparatus 400 (shown in FIGS. 1 and 2) has a greater opening ratio than the liquid crystal display apparatus including the dot area having the three pixel areas that have substantially the same size of area and structure by about 18%.

Each of the domains of the liquid crystal display apparatus 400 (shown in FIGS. 1 and 2) has a smaller width than that of a liquid crystal display apparatus (not shown) having three pixel regions of the same size and single common opening portion, thereby increasing a response speed.

The opening ratio and response speed of the liquid crystal display apparatus 400 are increased to improve image display quality.

The liquid crystal layer 300 is interposed between the pixel electrode 150 and the common electrode 230. Liquid crystals of the liquid crystal layer 300 are aligned in response to an electric field formed between the pixel electrode 150 and the common electrode 230.

An alignment of the liquid crystals is determined by the electric field applied thereto in each of the first, second and third pixel regions P1, P2 and P3. Therefore, the alignment of the liquid crystals in each of the first, second and third pixel regions P1, P2 and P3 may be different from each other. In FIGS. 1 and 2, an amount of the electric field in each of the first, second and third pixel areas P1, P2 and P3 is substantially the same, so that the alignment of the liquid crystals in each of the first, second and third pixel regions P1, P2 and P3 may be substantially the same.

The pixel electrode 150 and the common electrode 230 have the opening portions 151, 231, 233 and 234, so that the alignment of the liquid crystals in each of the first, second and third pixel regions P1, P2 and P3 is changed to form the domains in each of the first, second and third pixel regions P1, P2 and P3. The alignment of the liquid crystals in each of the first, second and third pixel regions P1, P2 and P3 is changed along the opening portions 151, 231, 233 and 234 to form the domains.

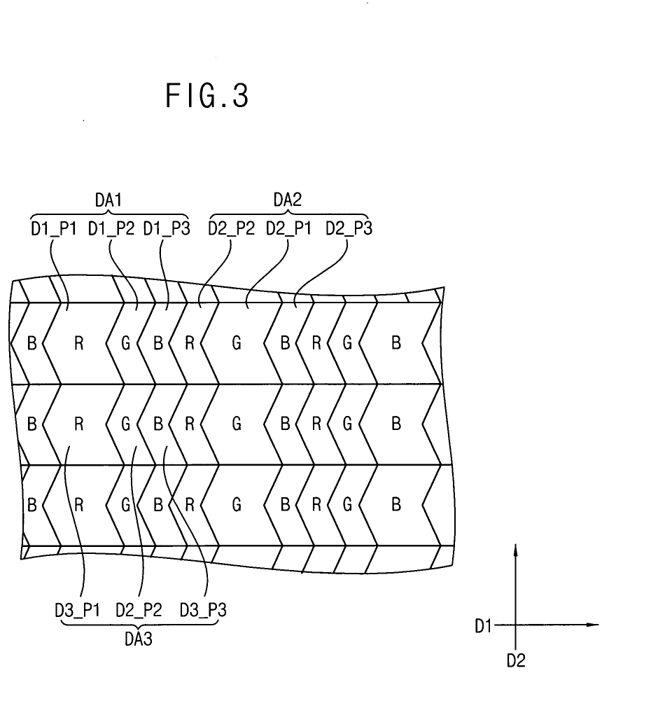

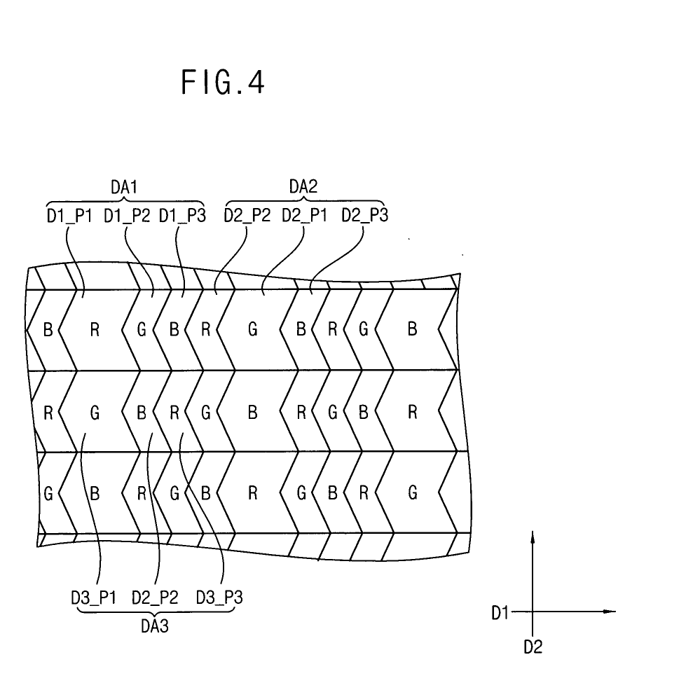

FIG. 3 is a plan view illustrating a method of arranged red (R), green (G) and blue (B) color pixels shown in FIG. 2. FIG. 4 is a plan view illustrating a method of arranging red (R), green (G) and blue (B) color pixels in accordance with another embodiment of the present invention. In FIGS. 3 and 4, dot areas of the liquid crystal display apparatus have substantially the same structure as that described with respect to FIGS. 1 and 2.

Referring to FIG. 3, a first dot area DA1 is adjacent to a second dot area DA2 in a first direction D1. Arrangement of first, second and third pixel areas D1_P1, D2_P1, D1_P2, D2_P2, D1_P3 and D2_P3 are different from each other.

First, second and third pixel areas D1_P1, D1_P2 and D1_P3 of the first dot area DA1 are arranged in the first direction D1, in sequence. Second, first and third pixel areas D2_P2, D2_P1 and D2_P3 of the second dot area DA2 are arranged in the first direction D1, in sequence, adjacent to the first dot area DA1.

In FIG. 3, red (R), green (G) and blue (B) color pixels of the first and second dot areas DA1 and DA2 are arranged in the first direction D1. In each of the first, second and third dot areas DA1, DA2 and DA3, the R, G and B color pixels are arranged in the first direction D1, in sequence, to increase color reproducibility. For example, the R color pixel is in the first pixel area D1_P1 of the first dot area DA1 and the second pixel area D2_P2 of the second dot area D2. The G color pixel is in the second pixel area D1_P2 of the first dot area DA1 and the first pixel area D2_P1 of the second dot area D2. The B color pixel is in the third pixel area D1_P3 of the first dot area DA1 and the third pixel area D2_P3 of the second dot area DA2.

The arrangement of the first, second and third pixel areas of each of the first and second dot areas D1 and D2 that are arranged in the first direction D1 is changed, and the arrangement of the R, G and B color pixels is not changed to decrease a color shift, thereby improving the color reproducibility.

The first dot area DA1 is adjacent to the third dot area DA3 in the second direction D2. First, second and third pixel areas D3_P1, D3_P2 and D3_P3 of the third dot area DA3 have substantially the same order as the first, second and third pixel areas D1_P1, D1_P2 and D1_P3 of the first dot area DA1.

Thus, the first pixel area D1_P1 of the first dot area DA1 is adjacent to the first pixel area D3_P1 of the third dot area DA3. The second pixel area D1_P2 of the first dot area DA1 is adjacent to the second pixel area D3_P2 of the third dot area DA3. The third pixel area D1_P3 of the first dot area DA1 is adjacent to the third pixel area D3_P3 of the third dot area DA3.

The arrangement of the first, second and third pixel areas D1_P1, D1_P2 and D1_P3 of the first dot area DA1 is substantially the same as the arrangement of the first, second and third pixel areas D3_P1, D3_P2 and D3_P3 of the third dot area DA3.

In FIG. 3, the R color pixel is in the first pixel area D1_P1 of the first dot area DA1 and the first pixel area D3_P1 of the third dot area DA3. The G color pixel is in the second pixel area D1_P2 of the first dot area DA1 and the second pixel area D3_P2 of the third dot area DA3. The B color pixel is in the third pixel area D1_P3 of the first dot area DA1 and the third pixel area D3_P3 of the third dot area DA3.

Each of the first pixel areas D1_P1, D2_P1 and D3_P1 has a greater size than each of the second and third pixel areas D1_P2, D2_P2, D3_P2, D1_P3, D2_P3 and D3_P3. Thus, when the dot areas of the liquid crystal display apparatus 400 are arranged in the second direction D2, a portion of the color pixels in the first pixel areas D1_P1, D2_P1 and D3_P1 may display a line on the display apparatus, thereby displaying a color shift on the display apparatus.

To substantially prevent the color shift, the first, second and third pixel areas of each of dot areas of FIG. 4 are arranged substantially the same as the arrangement of the first, second and third pixel areas of each of the dot areas of FIG. 3, and the R, G and B color pixels of FIG. 4 are arranged different from the arrangement of the R, G and B color pixels of FIG. 3.

Referring to FIG. 4, an arrangement of first, second and third pixel areas D1_P1, D1_P2 and D1_P3 of the first dot area DA1 is substantially the same as that of first, second and third pixel areas D3_P1, D3_P2 and D3_P3 of the third dot area DA3. An arrangement of R, G and B color pixels of the first dot area DA1 is different from that of R, G and B color pixels of the third dot area DA3.

In FIG. 4, the R color pixel is in the first pixel area D1_P1 of the first dot area DA1. The G color pixel is in the second pixel area D1_P2 of the first dot area DA1. The B color pixel is in the third pixel area D1_P3 of the first dot area DA1.

The G color pixel is in the first pixel area D3_P1 of the third dot area DA1. The B color pixel is in the second pixel area D3_P2 of the third dot area DA1. The R color pixel is in the third pixel area D3_P3 of the third dot area DA1.

In FIG. 4, the arrangement of the first, second and third pixel areas of the first dot area D1 is substantially the same as that of the first, second and third pixel areas of the third dot area D3 in the second direction D2. The arrangement of the R, G and B color pixels of the first dot region D1 is different from the R, G and B color pixels of the third dot region D3 in the second direction D2. Therefore, a color shift on the display apparatus is decreased to improve color reproducibility.

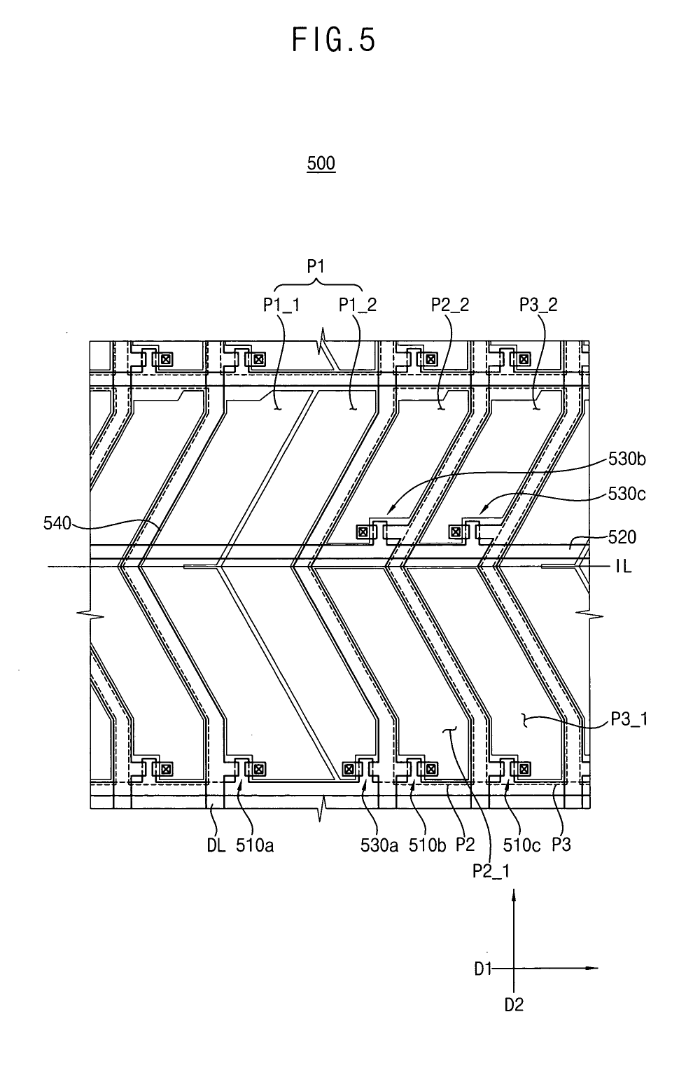

FIG. 5 is a partial plan view illustrating a liquid crystal display apparatus according to other example embodiment of the present invention.

Referring to FIG. 5, the liquid crystal display apparatus 500 of FIG. 5 is substantially the same as the liquid crystal display apparatus 400 shown FIGS. 1 and 2. The liquid display apparatus further includes a sub gate line 510, a first film transistors 520a, 520b, 520c, second film transistors 530a, 530b, 530c, and pixel electrodes 540. The same reference numerals will be used to refer to the same or like parts as those described in FIGS. 1 and 2 and any further explanation concerning the above elements will be omitted.

The liquid crystal display apparatus 500 includes a plurality of dot areas DA. An image is displayed in the dot areas DA. Each of the dot areas DA includes first, second and third pixel areas P1, P2 and P3.

Each of the first, second and third pixel areas P1, P2 and P3 extends from a central line IL of the first, second and third pixel areas P1, P2 and P3 in a direction that forms a predetermined angle with respect to a second direction D2. Each of the first, second and third pixel areas P1, P2 and P3 has a V shape when viewed on a plane.

The first, second and third pixel areas P1, P2 and P3 are arranged along a first direction D1 that is substantially perpendicular to the second direction D2. The first pixel area P1 has a greater size than each of the second and third pixel areas P2 and P3.

The first pixel area P1 is divided into a first main area P1_1 and a first sub area P1_2. Each of the first main area P1_1 and the first sub area P1_2 forms the predetermined angle with respect to the second direction D2. The second pixel area P2 is divided into a second main area P2_1 and a second sub area P2_2 by the central line IL. The third pixel area P3 is divided into a third main area P3_1 and a third sub area P3_2 by the central line IL.

The liquid crystal display apparatus 500 includes gate lines GL extending in the first direction D1, data lines DL extended in the second direction D2, and a plurality of first thin film transistors (TFT) 510a, 510b and 510c. Each of the first thin film transistors 510a, 510b and 510c is electrically connected to one of the data lines DL and one of the gate lines GL.

Each of the first thin film transistors 510a, 510b and 510c is disposed in each of the first, second and third main areas P1_1, P2_1 and P3_1 for controlling an application of a first signal voltage to each of the first, second and third main areas P1_1, P2_1 and P3_1. The first thin film transistors 510a, 510b and 510c of FIG. 5 are substantially the same as the thin film transistors 120 shown in FIGS. 1 and 2. Thus, any further explanation concerning the above elements will be omitted.

The liquid crystal display apparatus 500 may further include sub gate lines 520 extending in the first direction D1, a plurality of second thin film transistors 530a, 530b and 530c electrically connected to the sub gate lines 520, and pixel electrodes 540 electrically connected to the first and second thin film transistors 510a, 510b 510c, 530a, 530b and 530c, respectively.

The first sub gate lines 520 are adjacent to the central line IL, and transmit gate signals to the sub areas P1_2, P2_2 and P3_2.

The second thin film transistors 530a, 530b and 530c are disposed in the sub areas P1, P2 and P3, respectively. The second thin film transistors 530a, 530b and 530c control application of second signal voltages to the sub areas P1, P2 and P3. Each of the second signal voltages may have a smaller level than each of the first signal voltages.

The first main area P1_1 of the first pixel area P1 receives a first signal from the first sub area P1_2 of the first pixel area P1. The second main area P2_1 of the second pixel area P2 receives a second signal from the second sub area P2_2 of the second pixel area P2. The third main area P3_1 of the third pixel area P3 receives a third signal from the third sub area P3_2 of the third pixel area P3.

Alternatively, the first main area P1_1 of the first pixel area P1, the second main area P2_1 of the second pixel area P2 and the third main area P3_1 of the third pixel area P3 may receive substantially the same signals as the first sub area P1_2 of the first pixel area P1, the second sub area P2_2 of the second pixel area P2 and the third sub area P3_2 of the third pixel area P3, respectively.

When the first, second and third main areas P1_1, P2_1 and P3_1 receive substantially the same signal voltages as the first, second and third sub areas P1_2, P2_2 and P3_2, respectively, liquid crystals in the first, second and third main areas P1_1, P2_1 and P3_1 are aligned in substantially the same directions as those of the first, second and third sub areas P1_2, P2_2 and P3_2. The alignment of the liquid crystals is determined by the signal voltages applied thereto, so that the alignment of the liquid crystals in each of the first, second and third pixel areas P1, P2 and P3 is substantially the same.

When the first, second and third main areas P1_1, P2_1 and P3_1 receive substantially the same signal voltages as the first, second and third sub areas P1_2, P2_2 and P3_2, respectively, relative gray scales between each of the first, second and third main areas P1_1, P2_1 and P3_1 and each of the first, second and third sub areas P1_2, P2_2 and P3_2 may be distorted when viewed from a viewing angle other than 90 degrees.

For example, when viewed in front of the liquid crystal display apparatus (e.g., from substantially a 90 degree viewing angle), the first main area P1_1 displays higher gray scale values than the first sub area P1_2. When viewed on the lateral side (e.g., from a viewing angle other than substantially 90 degrees) of the liquid crystal display apparatus, the first sub area P1_2 may display higher gray scale values than the first main area P1_1. A lateral image display quality may be deteriorated, or a lateral gamma distortion may be displayed on the liquid crystal display apparatus.

In FIG. 5, to improve the lateral image display quality and to decrease the lateral gamma distortion, the first, second and third main areas P1_1, P2_1 and P3_1 receive different signal voltages from the first, second and third sub areas P1_2, P2_2 and P3_2 respectively.

In FIG. 5, each of the second and third pixel areas P2 and P3 is operated in substantially the same method as the first pixel area P1. Thus, any further explanation concerning the above elements will be omitted.

The first signal voltage is applied to the first main area P1_1 of the first pixel area P1, and the second signal voltage having a lower level than the first signal voltage is applied to the first sub area P1_2 of the first pixel area P1.

Thus, the liquid crystals in the first main area P1_1 of the first pixel P1 have a different alignment from those in the first sub area P1_2 of the first pixel area P1, so that light having passed through the liquid crystal layer 300 (shown in FIG. 2) in the first main area P1_1 of the first pixel area P1 to be incident into the color filter layer 220 (shown in FIG. 2) has different light transmittance from a light having passed through the liquid crystal layer 300 (shown in FIG. 2) in the first sub area P1_2 of the first pixel area P1 to be incident into the color filter layer 220. Therefore, the first main area P1_1 of the first pixel area P1 has a different gray scale from the first sub area P1_2 of the first pixel area P1.

Light having passed through the first, second and third main areas P1_1, P2_1 and P3_1 are mixed with light having passed through the first, second and third sub areas P1_2, P2_2 and P3_2 to decrease the lateral gamma distortion between each of the first, second and third main areas P1_1, P2_1 and P3_1 and each of the first, second and third sub areas P1_2, P2_2 and P3_2. The lateral gamma distortion of the liquid crystal display apparatus 500 is decreased to improve the lateral image display quality.

According to the liquid crystal display apparatus of FIG. 5, each the first, second and third pixel areas P1, P2 and P3 includes the first thin film transistors 510a, 510b, 510c, and the second thin film transistors 530a, 530b and 530c to apply different signal voltages between each of the first, second and third main areas P1_1, P2_1 and P3_1 and each of the first, second and third sub areas P1_2, P2_2 and P3_2.

Alternatively, the liquid crystal display apparatus 500 may further include a coupling capacitor in each of the first, second and third pixel areas P1, P2 and P3, so that each of the first, second and third main areas P1_1, P2_1 and P3_1 may receive different signal voltages from each of the first, second and third sub areas P1_2, P2_2 and P3_2. The coupling capacitor is disposed in each of the first, second and third sub areas P1_2, P2_2 and P3_2, and is electrically connected to the first thin film transistors 501a, 510b and 510c. The coupling capacitor decreases a level of each of the signal voltages applied to each of the main areas P1_1, P2_1 and P3_1 to apply each of the signal voltages having decreased level to each of the first, second and third sub areas P1_2, P2_2 and P3_2.

The pixel electrodes 540 are disposed in the first, second and third main areas P1_1, P2_1 and P3_1 and the first, second and third sub areas P1_2, P2_2 and P3_2. The pixel electrodes 540 are electrically connected to the first thin film transistors 510a, 510b, 510c, and second thin film transistors 530a, 530b and 530c to apply the first and second signal voltages to the liquid crystal layer 300 (shown FIG. 2). The pixel electrodes 540 include a transparent conductive material. Examples of the transparent conductive material that can be used for the pixel electrodes 540 include indium tin oxide (ITO), tin oxide (TO), zinc oxide (ZO), indium zinc oxide (IZO), indium tin zinc oxide (ITZO), etc.

The liquid crystal display apparatus 500 may further include a common electrode (not shown) corresponding to the pixel electrodes 540. Here, the common electrode (not shown) is substantially the same as in FIGS. 1 and 2. Thus, any further explanation concerning the above elements will be omitted.

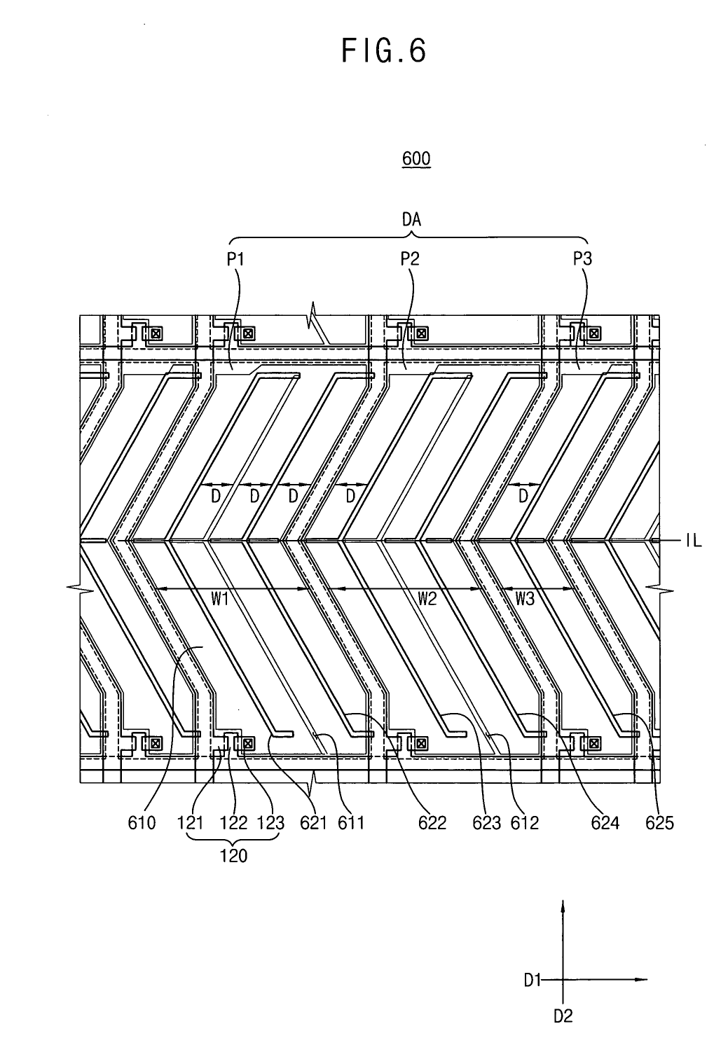

FIG. 6 is a plan view illustrating a liquid crystal display apparatus according to another embodiment of the present invention.

The liquid crystal display apparatus of FIG. 6 is the same as in FIGS. 1 and 2, and further includes first, second and third pixel areas, pixel electrodes and a common electrode. Thus, the same reference numerals will be used to refer to the same or like parts as those described in FIGS. 1 and 2 and any further explanation concerning the above elements will be omitted.

The liquid crystal display apparatus 600 includes a plurality of dot areas DA. An image is displayed in the dot areas DA. Each of the dot areas DA includes first, second and third pixel areas P1, P2 and P3.

Each of the first, second and third pixel areas P1, P2 and P3 is extends from a central line IL of the first, second and third pixel areas P1, P2 and P3 in a direction that forms a predetermined angle with respect to a second direction D2. Each of the first, second and third pixel areas P1, P2 and P3 has a V shape when viewed on a plane.

Each of the first pixel area P1 and the second pixel area P2 has a greater size than the third pixel area P3. In FIG. 6, the first, second and third pixel areas P1, P2 and P3 have substantially the same length. A width W1 of the first pixel area P1, a width W2 of the second pixel area P2 and a width W3 of the third pixel area P3 are different from each other. The width W1 of the first pixel area P1 is substantially the same as the width W2 of the second pixel area P2. The width W3 of the third pixel P3 is smaller than each of the width W1 of the first pixel area P1 and the width W2 of the second pixel area P2.

The liquid crystal display apparatus 600 includes gate lines GL extending in a first direction D1 that are substantially perpendicular to the second direction D2, data lines DL extending in the second direction D2, and thin film transistors (TFT) 120. Each of the thin film transistors 120 is electrically connected to one of the gate lines GL and one of the data lines DL.

The liquid crystal display apparatus 600 may further include pixel electrodes 510 and a common electrode. The pixel electrodes 510 are electrically connected to the thin film transistors 120. The common electrode is on the pixel electrodes 610.

Each of the pixel electrodes 610 is disposed in each the first, second and third pixel areas P1, P2 and P3. The pixel electrodes 610 are electrically insulated from each other. The pixel electrodes 610 apply signal voltages to a liquid crystal layer 300 (shown in FIG. 2). The pixel electrodes 610 include a transparent material. Examples of the transparent material that can be used for the pixel electrodes 610 include indium tin oxide (ITO), tin oxide (TO), zinc oxide (ZO), indium zinc oxide (IZO), indium tin zinc oxide (ITZO), etc. The pixel electrodes 610 are partially removed to form first and second pixel opening portions 611 and 612 in the first and second pixel areas P1 and P2, respectively.

The first pixel opening portion 611 is disposed in the first pixel area P1, and the second opening portion 612 is disposed in the second pixel area P2. In FIG. 6, the first pixel opening portion 611 has substantially the same shape as the second pixel opening portion 612. Thus, any further explanation concerning the above elements will be omitted.

A center of each of the first and second pixel opening portions 611 and 612 lies on the central line IL, and each of the first and second pixel opening portions 611 and 612 extends from the central line IL. Each of the first and second pixel opening portions 611 and 612 forms the predetermined angle with respect to the second direction D2, and is arranged substantially parallel to the V-shaped sides of each of the first and second pixel areas P1 and P2. A distance between a left side of the first pixel area P1 and the first opening portion 611 is substantially the same as a distance between a right side of the first pixel area P1 and the first opening portion 611. A distance between a left side of the second pixel area P2 and the second opening portion 612 is substantially the same as a distance between a right side of the second pixel area P2 and the second opening portion 612.

The common electrode includes a transparent conductive material. The common electrode may include substantially the same material as the pixel electrodes 610. Examples of the transparent conductive material that can be used for the common electrode include indium zinc oxide (IZO), zinc oxide (ZO), tin oxide (TO), indium tin oxide (ITO), indium tin-zinc oxide (ITZO), etc. The common electrode is partially removed to form first, second, third, fourth and fifth common opening portions 621, 622, 623, 624 and 625. The color filter layer 220 (shown in FIG. 2) may be partially exposed through the first, second, third, fourth and fifth common opening portions 621, 622, 623, 624 and 625.

A center of each of the first, second, third, fourth and fifth common opening portions 621, 622, 623, 624 and 625 lies substantially on the central line IL, and each of the first, second, third, fourth and fifth common opening portions 621, 622, 623, 624 and 625 extends from the central line IL. Each of the first, second, third, fourth and fifth common opening portions 621, 622, 623, 624 and 625 forms the predetermined angle with respect to the central line IL, and is arranged substantially parallel to the V-shaped sides of each of the first, second and third pixel areas P1, P2 and P3.

The first and second common opening portions 621 and 622 are disposed in the first pixel area P1. The first and second common opening portions 621 and 622 are disposed on opposite sides with respect to the first pixel opening portion 611.

The third and fourth common opening portions 623 and 624 are disposed in the second pixel area P2, and are disposed on opposite sides with respect to the second pixel opening portion 612.

The fifth common opening portion 625 lies substantially on a center of the third pixel area P3.

A plurality of domains are formed in the dot areas DA by the first and second pixel opening portions 611 of the pixel electrodes 610 and the first, second, third, fourth and fifth common opening portions 621, 622, 623, 624 and 625 of the common electrode. In FIG. 6, the first pixel opening portion 611, the first common opening portion 621 and the second common opening portion 622 are disposed in the first pixel area P1. The second pixel opening portion 612, the third common opening portion 621 and the fourth common opening portion 622 are disposed in the second pixel area P2. The fifth common opening portion 625 is disposed in the third pixel area P3. Each of the domains of the dot area DA has a constant width D. In FIG. 6, the width D of each of the domains is about 15 μm to about 40 μm.

The first, second and third pixel areas P1, P2 and P3 of each of the dot areas DA have different sizes from each other. The domains of the first, second and third pixel areas P1, P2 and P3 have a substantially same width D. In FIG. 6, the width W3 of the third pixel area P3 is about a half of each of the first and second pixel areas P1 and P2. The size of the third pixel area P3 is less than the size of the first and second pixel areas P1 and P2, so that the width D of each of the domains may be increased. When the width D of each of the domains is increased, an opening ratio of each of the dot areas DA and a response speed of the liquid crystal display apparatus 600 are improved.

Alternatively, each of the first, second and third pixel areas P1, P2 and P3 of the liquid crystal display apparatus 600 may be divided into main and sub areas.

The first pixel areas P1 may be divided into a first main area and a first sub area, and the second pixel area P2 may be divided into a second main area and a second sub area. Each of the first and second main areas and the first and second sub areas forms the predetermined angle with respect to the second direction D2. The third pixel area P3 that is smaller than the first and second pixel areas P1 and P2 is divided into a third main area and a third sub area by the central line IL.

To divide each of the first, second and third pixel areas P1, P2 and P3 into the main and sub areas, the liquid crystal display apparatus 600 may further include auxiliary thin film transistors, coupling capacitors, etc.

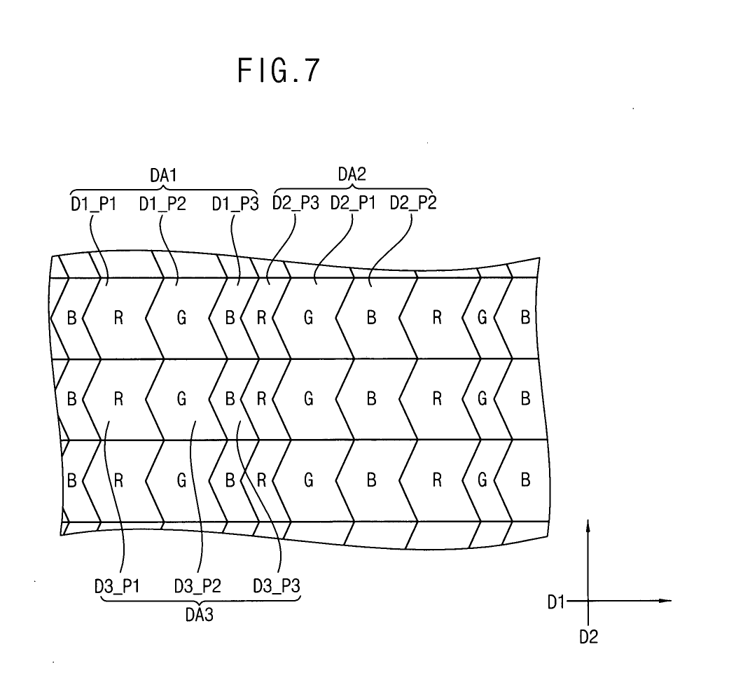

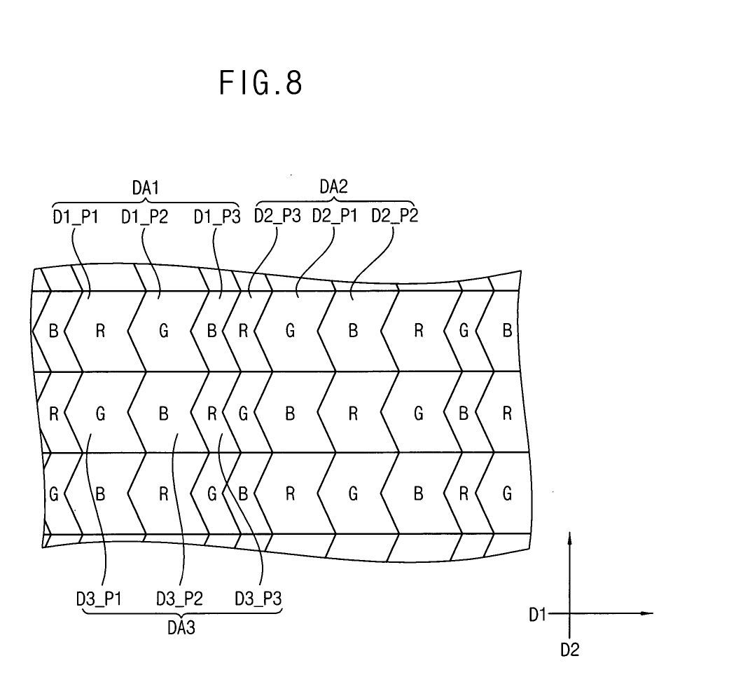

FIG. 7 is a plan view illustrating a method of arranging red (R), green (G) and blue (B) color pixels of a liquid crystal display apparatus shown in FIG. 6. FIG. 8 is a plan view illustrating a method of arranging red (R), green (G) and blue (B) color pixels in accordance with another embodiment of the present invention. In FIGS. 7 and 8, the first, second and third dot areas DA1, DA2 and DA3 have substantially the same structure except for an arrangement of red (R), green (G) and blue (B) dolor pixels.

Referring to FIG. 7, a first dot area DA1 is adjacent to a second dot area DA2 in a first direction D1. Arrangement of first, second and third pixel areas D1_P1, D2_P1, D1_P2, D2_P2, D1_P3 and D2_P3 are different from each other.

First, second and third pixel areas D1_P1, D1_P2 and D1_P3 of the first dot area DA1 are arranged in the first direction D1, in sequence. Third, first and second pixel areas D2_P2, D2_P1 and D2_P3 of the second dot area DA2 are arranged in the first direction D1, in sequence, adjacent to the first dot area DA1.

In FIG. 7, red (R), green (G) and blue (B) color pixels of the first and second dot areas DA1 and DA2 are arranged in the first direction D1. In each of the first, second and third dot areas DA1, DA2 and DA3, the R, G and B color pixels are arranged in the first direction D1, in sequence, to increase color reproducibility. For example, the R color pixel is disposed in the first pixel area D1_P1 of the first dot area DA1 and the third pixel area D2_P3 of the second dot area DA2. The G color pixel is disposed in the second pixel area D1_P2 of the first dot area D1 and the first pixel area D2_P1 of the second dot area DA2. The B color pixel is disposed in the third pixel area D1_P3 of the first dot area D1 and the second pixel area D2_P2 of the second dot area D2.

The arrangement of the first, second and third pixel areas of each of the first and second dot areas D1 and D2 that are arranged in the first direction D1 is changed, and the arrangement of the R, G and B color pixels is not changed to decrease a color shift, thereby improving the color reproducibility.

The first dot area DA1 is adjacent to the third dot area DA3 in the second direction D2. First, second and third pixel areas D3_P1, D3_P2 and D3_P3 of the third dot area DA3 have substantially the same order as the first, second and third pixel areas D1_P1, D1_P2 and D1_P3 of the first dot area DA1.

For example, the R, G and B color pixels are disposed in the first, second and third pixel areas D3_P1, D3_P2 and D3_P3 of the third dot area DA3. The R color pixel is disposed in the first pixel area D3_P1 of the third dot area DA3. The G color pixel is disposed in the second pixel area D3_P2 of the third dot area DA3. The B color pixel is disposed in the third pixel area D3_P3 of the third dot area DA3.

In FIG. 7, each of the first and second pixel areas D1_P1, D1_P2, D2_P1, D2_P2, D3_P1 and D3_P2 has a greater size than each of the third pixel areas D1_P3, D2_P3 and D3_P3. Thus, when the dot areas of the liquid crystal display apparatus 600 (shown in FIG. 6) are arranged in the second direction D2, a portion of the color pixels in the first and second pixel areas D1_P1, D2_P1, D3_P1, D1_P2, D2_P2 and D3_P2 may display a line on the liquid crystal display apparatus, thereby displaying a color shift.

To substantially prevent the color shift, an arrangement of first, second and third pixel areas of each of dot areas of FIG. 8 is substantially the same as that of the first, second and third pixel areas of each of the dot areas of FIG. 7, and an arrangement of R, G and B color pixels of FIG. 8 is different from that of the R, G and B color pixels of FIG. 7.

Referring to FIG. 8, an arrangement of first, second and third pixel areas D1_P1, D1_P2 and D1_P3 of the first dot area DA1 is substantially the same as that of first, second and third pixel areas D3_P1, D3_P2 and D3_P3 of the third dot area DA3. An arrangement of R, G and B color pixels of the first dot area DA1 is different from that of R, G and B color pixels of the third dot area DA3.

In FIG. 8, the R color pixel is disposed in the first pixel area D1_P1 of the first dot area DA1. The G color pixel is disposed in the second pixel area D1_P2 of the first dot area DA1. The B color pixel is disposed in the third pixel area D1_P3 of the first dot area DA1.

The G color pixel is disposed in the first pixel area D3_P1 of the third dot area DA1. The B color pixel is disposed in the second pixel area D3_P2 of the third dot area DA1. The R color pixel is disposed in the third pixel area D3_P3 of the third dot area DA1.

In FIG. 8, the arrangement of the first, second and third pixel areas of the first dot area D1 is substantially the same as that of the first, second and third pixel areas of the third dot area D3 in the second direction D2. The arrangement of the R, G and B color pixels of the first dot region D1 is different from the R, G and B color pixels of the third dot region D3 in the second direction D2. Therefore, a color shift on the display apparatus is decreased to improve color reproducibility.

According to an embodiment of the present invention, the liquid crystal display apparatus includes the first, second and third pixel areas having different sizes from each other to increase the width of the domains of each of the dot areas. Thus, the opening ratio and the response speed of the liquid crystal display apparatus are increased to improve image display quality.

Although exemplary embodiments of the present invention have been described, it is understood that the present invention should not be limited to exemplary embodiments described herein but various changes and modifications can be made by one ordinary skilled in the art within the spirit and scope of the present invention.

What is claimed is:

1. A display apparatus comprising:
a first substrate including a dot area having a plurality of pixel areas having at least two different sizes among the plurality of pixel areas, each of the pixel areas forming a predetermined angle with respect to a line of the first substrate in a first direction, and each of the plurality of pixel areas extending substantially symmetrically from the line in the first direction;
a pixel electrode disposed on the first substrate;
a second substrate; and
a common electrode disposed on a surface of the second substrate adjacent to the pixel electrode.

2. The display apparatus of claim 1, wherein the plurality of pixel areas comprise a first pixel area, a second pixel area and a third pixel area, and the first pixel area has a different size from each of the second and third pixel areas.

3. The display apparatus of claim 2, wherein the first pixel area is greater than each of the second and third pixel areas.

4. The display apparatus of claim 3, wherein the pixel electrode comprises a first opening portion in the first pixel area, the first opening portion extending from the line in the first direction to form the predetermined angle with respect to the line in the first direction substantially parallel to the first pixel area.

5. The display apparatus of claim 4, wherein the common electrode comprises a second opening portion, the second opening portion extending from the line in the first direction to form the predetermined angle with respect to the line in the first direction substantially parallel to the pixel areas.

6. The display apparatus of claim 5, wherein the common electrode comprises two second opening portions, the second opening portions being opposite to each other with respect to the first opening portion.

7. The display apparatus of claim 6, wherein the common electrode has a second opening portion in each of the second and third pixel areas.

8. The display apparatus of claim 5, wherein the first, second and third pixel areas are divided by the first and second opening portions, and the divided areas a width that is substantially the same in the second direction.

9. The display apparatus of claim 8, wherein the width of each of the divided areas is about 15 μm to about 40 μm.

10. The display apparatus of claim 5, wherein the first pixel area is divided into a first sub area and a second sub area with respect to the first opening portion, wherein a portion of the pixel electrode in the first sub area and a portion of the pixel electrode in the second sub area receive a first signal voltage and a second signal voltage that is different from the first signal voltage, respectively.

11. The display apparatus of claim 5, wherein the second pixel area is divided into a third sub area and a fourth sub area with respect to the line in the first direction, wherein a portion of the pixel electrode in the third sub area and a portion of the pixel electrode in the fourth sub area receive a third signal voltage and a fourth signal voltage that is different from the third signal voltage, respectively.

12. The display apparatus of claim 5, wherein the third pixel area is divided into a fifth sub area and a sixth sub area with respect to the line in the first direction, wherein a portion of the pixel electrode in the fifth sub area and a portion of the pixel electrode in the sixth sub area receive a fifth signal voltage and a sixth signal voltage that is different from the fifth signal voltage, respectively.

13. The display apparatus of claim 2, wherein the first to third pixel areas are arranged in the first direction, and an arrangement of the first pixel area, the second pixel area and the third pixel area of the dot area is different from an arrangement of a first pixel area, a second pixel area and a third pixel area of an adjacent dot area.

14. The display apparatus of claim 2, further comprising color pixels displaying color images using light, and wherein an arrangement of the color pixels of the dot area is different from an arrangement of color pixels of an adjacent dot area.

15. The display apparatus of claim 14, wherein the arrangement of the color pixels of the dot area is different from the arrangement of the color pixels of the adjacent dot area in a second direction that is different from the first direction.

16. The display apparatus of claim 2, wherein the second pixel area has substantially the same size as the third pixel area, and the first pixel area has a smaller size than each of the second and third pixel areas.

17. A display apparatus comprising:
a first substrate including a dot area having a first pixel area, a second pixel area that is greater than the first pixel area and a third pixel area that has substantially the same size as the second pixel area, each of the first pixel area, the second pixel area and the third pixel area forming a predetermined angle with respect to a line in a first direction of the first substrate, and the first pixel area, the second pixel area and the third pixel area extending substantially symmetrical from the line in the first direction;
a pixel electrode disposed on the first substrate;
a second substrate; and
a common electrode disposed on a surface of the second substrate adjacent to the pixel electrode.

18. The display apparatus of claim 17, wherein the pixel electrode comprises first opening portions in the second pixel area and the third pixel area, and each of the first opening portions extend from the line in the first direction to form the predetermined angle with respect to the line in the first direction substantially parallel to each of the second pixel area and the third pixel area.

19. The display apparatus of claim 18, wherein the common electrode comprises second opening portions, each of the second opening portion extending from the line in the first direction to form the predetermined angle with respect to the line in the first direction substantially parallel to the pixel areas.

20. The display apparatus of claim 19, wherein the common electrode further comprises two second opening portions in the second pixel area and the third pixel area, respectively.

21. The display apparatus of claim 19, wherein the common electrode further comprises a second opening portion in the first pixel area.

22. The display apparatus of claim 19, wherein the first pixel area, the second pixel area, and the third pixel area are divided by the first opening portion and the second opening portion, and the divided areas have a width that is substantially the same in a second direction.

23. The display apparatus of claim 22, wherein width of the divided areas corresponding to the second direction is about 15 μm to about 40 μm.

24. The display apparatus of claim 17, wherein the first pixel area is divided into a first sub area and a second sub area with respect to the line in the first direction, and a portion of the pixel electrode in the first sub area and a portion of the pixel electrode in the second sub area receive the first signal voltage and a second signal voltage that is different from the first signal voltage, respectively.

25. The display apparatus of claim 17, wherein the second pixel area is divided into a third sub area and a fourth sub area with respect to a first opening portion, and a portion of the pixel electrode in the third sub area and a portion of the pixel electrode in the fourth sub area receive a third signal voltage and a fourth signal voltage that is different from the third signal voltage, respectively.

26. The display apparatus of claim 17, wherein the third pixel area is divided into a fifth sub area and a sixth sub area with respect to a first opening portion, and a portion of the pixel electrode in the fifth sub area and a portion of the pixel electrode in the sixth sub area receive a fifth signal voltage and a sixth signal voltage that is different from the fifth signal voltage, respectively.

27. A display apparatus comprising:
a first substrate including a dot area having a plurality of pixel areas having different sizes, each of the pixel areas forming a predetermined angle with respect to a line in the first direction of the first substrate, each of the pixel areas extending substantially symmetrical from the line in the first direction, and each of the pixel areas including a main area receiving a first signal voltage and a sub area receiving a second signal voltage;
a pixel electrode disposed on the first substrate;
a second substrate; and
a common electrode disposed on a surface of the second substrate adjacent to the pixel electrode.

28. The display apparatus of claim 27, wherein the pixel areas comprise a first pixel area having a first size and a second pixel area having a second size that is smaller than the first size.

29. The display apparatus of claim 28, wherein the first pixel area is divided into the main area and the sub area by a line in a second direction that forms the predetermined angle with respect to the line in the first direction to cross the line in the first direction.

30. The display apparatus of claim 28, wherein the second pixel area is divided into the main area and the sub area by the line in the first direction.

31. The display apparatus of claim 27, wherein the first signal voltage is higher than the second signal voltage.
